(19) United States
(12) Patent Application Publication
(10) Pub. No.: US 2010/0164928 A1
(43) Pub. Date: Jul. 1, 2010

(54) DISPLAY DEVICE AND METHOD OF DRIVING SAME

(76) Inventors: Kyoung-Ju Shin, Hwaseong-si (KR); Chong-Chul Chai, Seoul (KR); Sei-Hyoung Jo, Seoul (KR)

Correspondence Address: Haynes and Boone, LLP;IP Section, 2323 Victory Avenue, SUITE 700, Dallas, TX, 75219, US

(21) Appl. No.: 12/504,562

(22) Filed: Jul. 16, 2009

(30) Foreign Application Priority Data
Dec. 29, 2008 (KR) 10-2008-0135662

(51) Int. Cl. G06F 3/038; G02B 26/02; G09G 3/36

(52) U.S. Cl. 345/211; 359/230; 345/92

(57) ABSTRACT

Embodiments of the present invention operate at least two microshutter electrodes with different voltages from each other for displaying grays. Also, a data voltage is applied to the microshutter electrodes after an initialization voltage when the display device has hysteresis characteristics such that erroneous operation due to the hysteresis characteristics is eliminated. As described herein, the display device including the microshutter electrodes may display subdivided grays.

### CROSS-REFERENCE TO RELATED APPLICATIONS

This application claims priority to and the benefit of Korean Patent Application No. 10-2008-0135662 filed in the Korean Intellectual Property Office on Dec. 29, 2008, the entire contents of which are incorporated herein by reference.

### BACKGROUND

1. Technical Field

Embodiments of the present invention generally relate to a display device and a method of driving the display device. More particularly, embodiments of the present invention relate to a display device and a method of driving it using microshutter electrodes for representing grays.

2. Related Art

Display devices have progressed from the well-known cathode ray tube (CRT) displays to flat panel displays, such as liquid crystal displays (LCDs), plasma display panels (PDPs), and the like. A CRT display displays an image by causing an electron beam to collide with a fluorescent material. The CRT display has a drawback in that as its size increases, its depth also increases, and thus it is difficult to increase the size of the display device.

In order to overcome the drawback, a plurality of types of flat panel displays are being developed. LCDs and PDPs are the most common examples of the flat panel display. The flat panel display, such as the LCD and PDP, has a merit in that even when its size increases, its depth does not increase, such that it may be mounted on the wall.

However, the LCD has a slow response speed, and the PDP has high power consumption. Due to the drawbacks of the known flat displays, new types of display devices are being developed.

The above information disclosed in this Background section is only for enhancement of understanding of the background of the invention and therefore it may contain information that does not form the prior art that is already known in this country to a person of ordinary skill in the art.

SUMMARY

Embodiments of the present invention generally provide a gray display through a display device using microshutter electrodes.

A display device according to an embodiment of the present invention includes: an insulation substrate; a pixel electrode formed on the insulation substrate and made of a transparent conductive material; an insulating layer disposed on the pixel electrode; and at least two microshutter electrodes, which are disposed on the insulating layer, made of a non-transparent conductive material for blocking light, electrically connected to each other so that the same voltage is applied to both, and opened and closed by applying different voltages.

The microshutter electrodes may be opened and closed through a static electricity force between the microshutter electrodes and the pixel electrode, and an elastic force of the microshutter electrodes. The microshutter electrodes may have different elastic forces. The microshutter electrodes may have a uniform width. The microshutter electrodes may have different widths. The microshutter electrodes may have a high stress portion meeting a portion where they are moved and a portion where they are fixed each other, and the widths of the high stress portions of the microshutter electrodes may be different. An additional film covering the high stress portion may be further included, the microshutter electrodes may have a high stress portion meeting a portion where they are moved and a fixed portion where they are fixed to each other, and the additional film may have different lengths or may be included at a different number per microshutter electrode. The microshutter electrodes may be made of different materials. An additional film covering the microshutter electrode may be further included, and the additional film may have different lengths per microshutter electrode. The static electricity forces between the pixel electrode and the microshutter electrodes may be different from each other. The pixel electrode may include at least two small portions corresponding to the microshutter electrodes and separated from each other by a predetermined interval. A central line of the small portions may accord with a central line of the microshutter electrodes. Overlapping widths between the small portions and the microshutter electrodes may be the same. The overlapping widths between the small portions and the microshutter electrodes may be different from each other. One end of each of the small portions may be connected to each other. A light blocking member blocking light transmitted between the microshutter electrodes may be further included. A thin film transistor electrically connected to the pixel electrode or the microshutter electrodes may be further included. A gate line, a data line, and a switching transistor and a reset transistor, each respectively including a gate electrode, a source electrode, and a drain electrode, may be further included, wherein the gate electrode of the switching transistor may be connected to the corresponding gate line, the source electrode of the switching transistor may be connected to the data line, and the drain electrode of the switching transistor may be connected to the microshutter electrodes. The gate electrode of the reset transistor may be connected to the previous gate line, the source electrode of the reset transistor may be connected to the pixel electrode, and the drain electrode of the reset transistor may be connected to the microshutter electrodes.

A method for driving a display device that includes a pixel electrode made of a transparent conductive material; at least two microshutter electrodes made of a non-transparent conductive material for blocking light, electrically connected to each other so that the same voltage is applied to each, and opened and closed through different voltages; a gate line; a data line; and a thin film transistor connected to the gate line, the data line, and the pixel electrode or the microshutter electrodes; the method according to an embodiment of the present invention includes: applying a gate-on voltage to the gate line; and alternately applying a reset voltage and a data voltage to the data line, wherein: the reset voltage and the data voltage are applied for at least respective portions of a time during which the gate-on voltage is applied, and the reset voltage is applied before the data voltage.

The reset voltage may be a voltage to initialize all the microshutter electrodes.

In a display device according to an embodiment of the present invention, one pixel includes at least two microshutter electrodes that are electrically connected to each other, and the microshutter electrodes are closed and opened by applying different voltages such that gray display according to the voltages is possible.

### BRIEF DESCRIPTION OF THE DRAWINGS

FIG. 1 is a cross-sectional view of a display device according to an embodiment of the present invention, showing an operation of a microshutter electrode;

FIG. 2 is a transmittance graph according to voltage applied to a microshutter electrode in accordance with an embodiment of the present invention;

FIG. 3 is a view showing a pixel structure of a display device according to an embodiment of the present invention;

FIG. 4 is a transmittance graph according to voltage applied to a microshutter electrode of the embodiment shown in FIG. 3; FIG. 5 is a view showing a pixel structure of a display device according to another embodiment of the present invention;

FIG. 6 is a transmittance graph according to voltage applied to a microshutter electrode of the embodiment shown in FIG. 5;

FIG. 7 is a view showing a pixel structure of a display device according to another embodiment of the present invention;

FIG. 8 is a view showing a pixel structure of a display device according to another embodiment of the present invention;

FIG. 9 to FIG. 12 are views showing other embodiments according to the present invention;

FIG. 13 is a waveform diagram of a gate voltage and a data voltage applied to a display device according to an embodiment of the present invention;

FIG. 14 is a graph showing hysteresis of transmittance versus voltage of a display device according to an embodiment of the present invention;

FIG. 15 is a waveform diagram of a gate voltage and a data voltage applied to a display device according to another embodiment of the present invention; and

FIG. 16 is a pixel circuit diagram of a display device according to another embodiment of the present invention.

### DETAILED DESCRIPTION

Embodiments of the present invention will be described more fully hereinafter with reference to the accompanying drawings, in which examples of embodiments of the invention are shown. As those skilled in the art would realize, the described embodiments may be modified in various different ways, all without departing from the spirit or scope of the present invention.

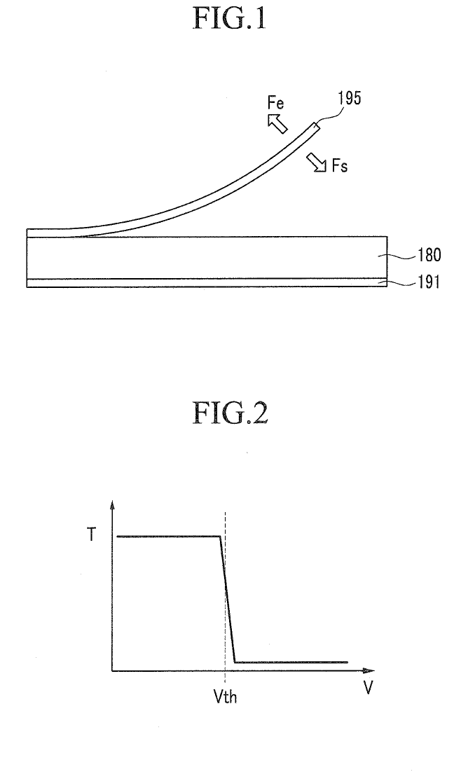

Firstly, a display device according to an embodiment of the present invention and a curved line of a voltage-transmittance according to an operation of a microshutter electrode will be described with reference to FIG. 1 and FIG. 2. FIG. 1 is a cross-sectional view of a display device according to an embodiment of the present invention, showing operation of a microshutter electrode, and FIG. 2 is a transmittance graph according to voltage applied to a microshutter electrode in accordance with an embodiment.

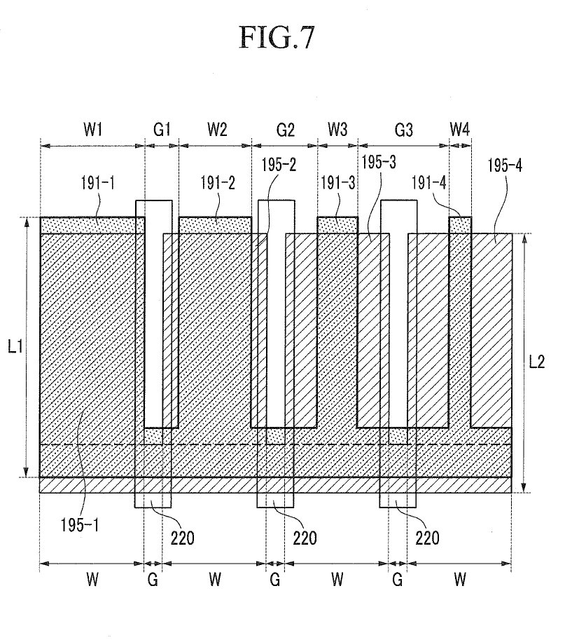

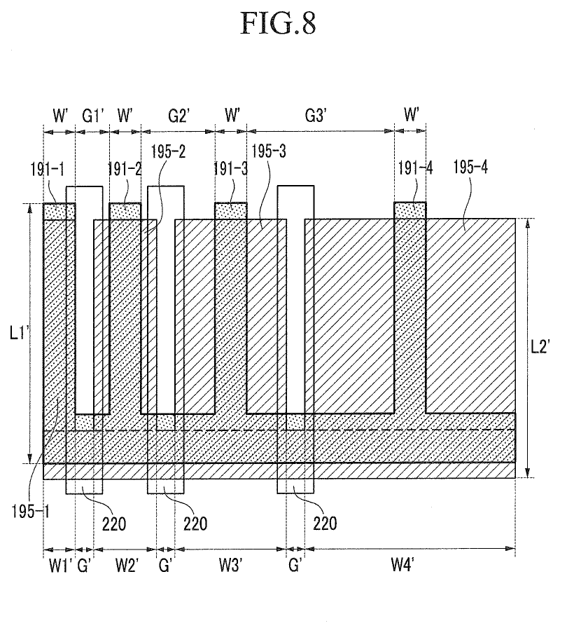

A display device may generally be classified into a display panel and a backlight unit (not shown). The display panel includes a lower substrate (not shown) and an upper substrate (not shown) disposed outermost. A thin film transistor (not shown), a pixel electrode 191, a microshutter electrode 195, and an insulating layer 180 for insulation between the pixel electrode 191 and the microshutter electrode 195 are formed in the display panel. The pixel electrode 191 may be made of a transparent conductive material, and the microshutter electrode 195 may be made of a non-transparent conductive material that blocks light. Also, for realizing colors, a color filter (not shown) and a light blocking member (220; referring to FIG. 7 and FIG. 8) for preventing leakage of the light may be further included. The thin film transistor may be formed under the pixel electrode 191 and the microshutter electrode 195, and the thin film transistor may be electrically connected to at least one of the pixel electrode 191 and the microshutter electrode 195. Hereafter, an embodiment in which the thin film transistor is connected to the microshutter electrode 195 will be described.

In addition, the backlight unit may include a light source, and a light guide (not shown) or a reflector (not shown) may be further included according to an embodiment. In the display device according to an embodiment of the present invention, light incident from the light source of the backlight unit to the display panel may be blocked or transmitted by operation of the microshutter electrode 195, thereby displaying images.

As shown in FIG. 1, the microshutter electrode 195 is operated by an elastic force Fe and a static electricity force Fs, the elastic force Fe is a characteristic of the microshutter electrode 195 itself, and the static electricity force Fs is a force generated between the microshutter electrode 195 and the pixel electrode 191 and may be operated as an attraction force or a repulsive force according to the embodiment. The case of an attraction force will be described in the present embodiment. The microshutter electrode 195 is located at a position where the elastic force Fe and the static electricity force Fs are balanced such that the voltage applied to the pixel electrode 191 or the microshutter electrode 195 is controlled to control the degree that the microshutter electrode 195 is opened. However, the microshutter electrode 195 is actually operated as in FIG. 2.

In FIG. 2, T represents transmittance, and V represents the voltage applied to the microshutter electrode 195. As seen in FIG. 2, the microshutter electrode 195 is opened at a lower voltage than a threshold voltage Vth for closing the microshutter electrode 195, thereby providing maximum transmittance, and the microshutter electrode 195 is suddenly operated at the threshold voltage Vth such that the transmittance is minimized at a higher voltage than the threshold voltage Vth. In this way, as the microshutter electrode 195 is suddenly operated at the threshold voltage Vth, it is difficult for the voltage applied to the microshutter electrode 195 to control the degree of opening thereof. Accordingly, the display device according to an embodiment of the present invention includes at least two microshutter electrodes 195 that are electrically connected to each other and to which are thereby applied the same voltage.

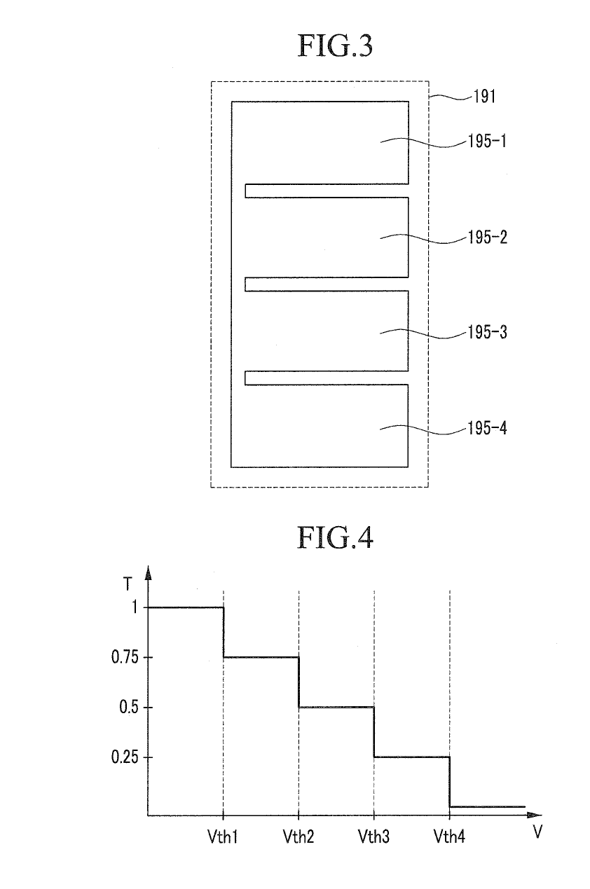

FIG. 3 is a view showing a pixel structure of a display device according to an embodiment of the present invention, and FIG. 4 is a transmittance graph according to voltage applied to a microshutter electrode of the embodiment shown in FIG. 3.

In the display device according to an embodiment of the present invention, one pixel includes four microshutter electrodes 195-1 to 195-4 that are electrically connected to each other and to which are thereby applied the same voltage. In FIG. 3, the microshutter electrodes 195-1 to 195-4 have the same width and length. Also, the pixel electrode 191 that is insulated from the microshutter electrodes 195-1 to 195-4 and occupies the whole region including the regions where the four microshutter electrodes 195-1 to 195-4 are disposed is formed under the microshutter electrodes 195-1 to 195-4. The pixel electrode 191 may be divided per each pixel, or may be formed into one body on the whole display panel.

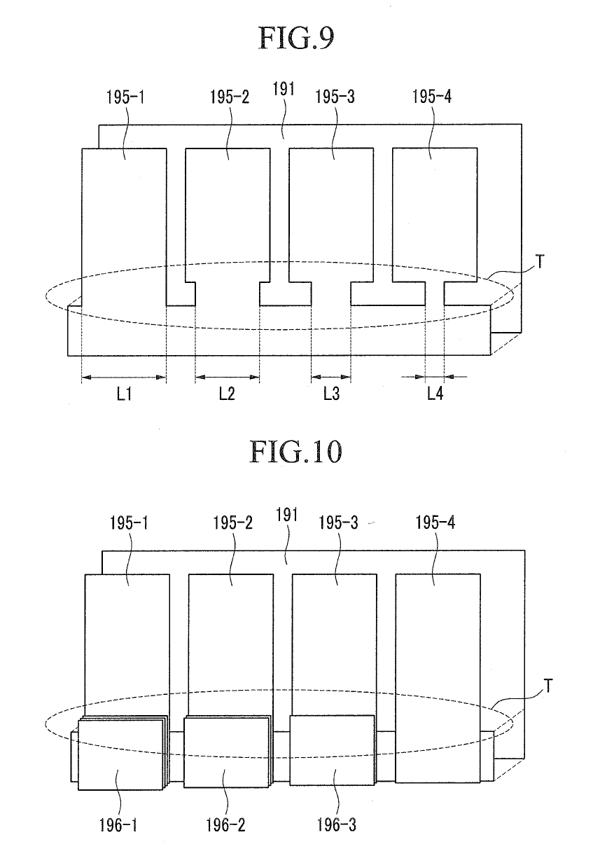

The microshutter electrodes 195-1 to 195-4 are formed with the same area; however, they have different elastic forces Fe. The microshutter electrodes 195-1 to 195-4 may be formed with different thicknesses to have the different elastic forces Fe while having the same area. Also, each of the microshutter electrodes 195-1 to 195-4 may be formed of a different material. Referring to FIG. 9, for example, there are various methods to provide the different elastic forces Fe to the microshutter electrodes 195-1 to 195-4, and some of these will be described with reference to FIG. 9 to FIG. 11 in detail.

When the elastic force Fe of the first microshutter electrode 195-1 is referred to as S1, the elastic force Fe of the second microshutter electrode 195-2 is referred to as S2, the elastic force Fe of the third microshutter electrode 195-3 is referred to as S3, and the elastic force Fe of the fourth microshutter electrode 195-4 is referred to as S4, the elastic forces of the microshutter electrodes 195-1 to 195-4 may have the relationship as shown by Equation 1 below.

S1<S2<S3<S4 (Equation 1)

In this way, the microshutter electrodes 195-1 to 195-4 have the elastic forces Fe different from each other such that different static electricity forces Fs are required between the pixel electrode 191 and the microshutter electrodes 195-1 to 195-4 to close the microshutter electrodes 195-1 to 195-4, and thereby the threshold voltages Vth at which the microshutter electrodes 195-1 to 195-4 are respectively closed are different from each other. In other words, a larger static electricity force Fs is required as the elastic force Fe of the microshutter electrode increases such that the threshold voltage Vth to operate the microshutter electrode is also increased. When the first threshold voltage of the first microshutter electrode 195-1 is referred to as Vth1, the second threshold voltage of the second microshutter electrode 195-2 is referred to as Vth2, the third threshold voltage of the third microshutter electrode 195-3 is referred to as Vth3, and the fourth threshold voltage of the fourth microshutter electrode 195-4 is referred to as Vth4, the threshold voltages Vth1 to Vth4 may have the relationship as shown in Equation 2 below.

[symbol]

Vth1<Vth2<Vth3<Vth4 (Equation 2)

The transmittance of the pixel according to the voltage applied to the microshutter electrodes 195-1 to 195-4 based on this equation is represented as in FIG. 4. In other words, all microshutter electrodes 195-1 to 195-4 are opened below the first threshold voltage Vth1 such that the maximum transmittance is represented. Next, the first microshutter electrode 195-1 is closed at the first threshold voltage Vth1 such that the light transmitted through the first microshutter electrode 195-1 is blocked. In the present embodiment, the width and length of each of the microshutter electrodes 195-1 to 195-4 are the same so that transmittance is decreased by a quarter of the maximum transmittance and a transmittance of three quarters of the maximum transmittance is represented. Next, the second microshutter electrode 195-2, the third microshutter electrode 195-3, and the fourth microshutter electrode 195-4 are respectively closed at the second threshold voltage Vth2, the third threshold voltage Vth3, and the fourth threshold voltage Vth4 such that the transmittance is decreased by a quarter of the maximum transmittance on the boundary of each threshold voltage, and the minimum transmittance is represented above the fourth threshold voltage Vth4.

As described above, it is possible to display four grays through one pixel according to the applied voltage. Also as described above, the microshutter electrode may be divided into four pieces; the microshutter electrode may be divided into a number more than or less than four, however, according to an embodiment.

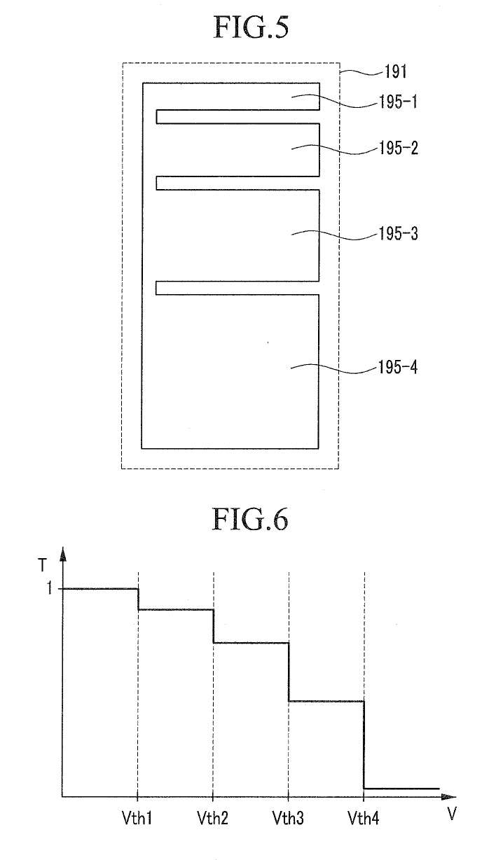

Moreover, FIG. 5 and FIG. 6 show another embodiment of the present invention. In the embodiment of FIG. 5, the widths of the microshutter electrodes are different from each other, which is different from FIG. 3. FIG. 5 is a view showing a pixel structure of a display device according to another embodiment of the present invention, FIG. 6 is a graph of transmittance according to voltage applied to a microshutter electrode according to the embodiment shown in FIG. 5.

In the display device according to the embodiment seen in FIG. 5, one pixel has four microshutter electrodes 195-1 to 195-4 that are electrically connected to each other and to which are thereby applied the same voltage. The microshutter electrodes 195-1 to 195-4 have the same length; however, they have different widths. Additionally, a pixel electrode 191 that is insulated from the microshutter electrodes 195-1 to 195-4 and is disposed on the whole region that the four microshutter electrodes 195-1 to 195-4 occupy is formed under the microshutter electrodes 195-1 to 195-4. The pixel electrode 191 may be divided per each pixel, or may be formed as one body on the whole display panel.

As seen in FIG. 5, the microshutter electrodes 195-1 to 195-4 may have different widths from each other to have different elastic forces Fe. For example, the microshutter electrode having the wider width among the microshutter electrodes 195-1 to 195-4 may require a larger force for operation. When the elastic force Fe of the first microshutter electrode 195-1 is referred to as S1, the elastic force Fe of the second microshutter electrode 195-2 is referred to as S2, the elastic force Fe of the third microshutter electrode 195-3 is referred to as S3, and the elastic force Fe of the fourth microshutter electrode 195-4 is referred to as S4, the elastic forces of the microshutter electrodes 195-1 to 195-4 may have the relationship as in Equation 3 below.

S1<S2<S3<S4 (Equation 3)

Also, the widths and areas of the microshutter electrodes 195-1 to 195-4 may be proportional to Equation 3.

As just described, the microshutter electrodes 195-1 to 195-4 may have different elastic forces Fe such that different static electricity forces Fs are required between the pixel electrode 191 and the microshutter electrodes 195-1 to 195-4 to close them, and thereby the threshold voltages Vth to close the microshutter electrodes 195-1 to 195-4 may be different. For example, a larger static electricity force Fs may be required as the microshutter electrode becomes larger such that the threshold voltage Vth to operate the microshutter electrode is larger. When the first threshold voltage of the first microshutter electrode 195-1 is referred to as Vth1, the second threshold voltage of the second microshutter electrode 195-2 is referred to as Vth2, the third threshold voltage of the third microshutter electrode 195-3 is referred to as Vth3, and the fourth threshold voltage of the fourth microshutter electrode 195-4 is referred to as Vth4, the threshold voltages Vth1 to Vth4 may have the relationship as in Equation 4 below.

Vth1<Vth2<Vth3<Vth4 (Equation 4)

The transmittance of the pixel according to the voltage applied to the microshutter electrodes 195-1 to 195-4 based on this equation is represented as in FIG. 6. As seen in FIG. 6, all microshutter electrodes 195-1 to 195-4 are opened below the first threshold voltage Vth1 such that the maximum transmittance is represented. Next, the first microshutter electrode 195-1 is closed at the first threshold voltage Vth1 such that the light transmitted through the first microshutter electrode 195-1 is blocked. In the present embodiment, the area of the first microshutter electrode 195-1 is the smallest, and the transmittance is decreased by the portion covered by the corresponding area. Next, the second microshutter electrode 195-2, the third microshutter electrode 195-3, and the fourth microshutter electrode 195-4 are respectively closed at the second threshold voltage Vth2, the third threshold voltage Vth3, and the fourth threshold voltage Vth4 such that the transmittance is decreased in proportion to the corresponding areas of the microshutter electrodes 195-2, 195-3, and 195-4 at the boundary of each threshold voltage, and the minimum transmittance is represented above the fourth threshold voltage Vth4.

As just described, it is possible to display four grays through one pixel according to the applied voltage, and the large grays are divided at the high luminance rather than the low luminance. The large grays may be formed on the low luminance according to the embodiment. The microshutter electrode may be divided into four pieces; however, the microshutter electrode may be divided into a number more than or less than four according to an embodiment.

FIG. 7 is a view showing a pixel structure of a display device according to another embodiment of the present invention. In the embodiment of FIG. 7, the width W of the microshutter electrodes 195 is like that in FIG. 3, and the microshutter electrodes 195 are separated from each other by a predetermined interval G. Differently from FIG. 3, however, a plurality of small portions of the pixel electrode 191 are formed inside the region corresponding to each microshutter electrode 195, and the small portions of each pixel electrode 191 have the same length L1; however, they have different widths W1, W2, W3, and W4. One end of each of the small portions of the pixel electrode 191 and the microshutter electrodes 195 are respectively connected to each other, to which, thereby, the same voltages are respectively applied.

As shown in FIG. 7, in the display device according to the current embodiment of the present invention, one pixel includes four microshutter electrodes 195-1 to 195-4 that are electrically connected to each other, to which, thereby, the same voltage is applied, and four small portions 191-1 to 191-4 of the pixel electrode 191 corresponding to the four microshutter electrodes 195-1 to 195-4. The microshutter electrodes 195-1 to 195-4 may have the same length L2 and the same width W, and the interval G between the microshutter electrodes 195-1 to 195-4 may be uniform. One end of each of the microshutter electrodes 195-1 to 195-4 may be connected to each other, to which thereby is applied the same voltage. In addition, the four small portions 191-1 to 191-4 of the pixel electrode 191 that are insulated from the microshutter electrodes 195-1 to 195-4 and respectively correspond to the microshutter electrodes 195-1 to 195-4 may be formed under the microshutter electrodes 195-1 to 195-4. The small portions 191-1 to 191-4 of each pixel electrode may have the same length L1; however, they may have different widths W1, W2, W3, and W4 and may be separated by different intervals G1, G2, and G3. The small portions 191-1 to 191-4 of the pixel electrode 191 may be disposed with reference to a central line of the length direction of the corresponding microshutter electrodes 195-1 to 195-4. Also, one end of each of the small portions 191-1 to 191-4 of each pixel electrode may be connected to each other, to which, thereby, the same voltage may be applied.

The microshutter electrodes 195-1 to 195-4 may be made of the same material, and may have the same width W such that they have the same elastic force Fe. When the elastic force Fe of the first microshutter electrode 195-1 is referred to as S1, the elastic force Fe of the second microshutter electrode 195-2 is referred to as S2, the elastic force Fe of the third microshutter electrode 195-3 is referred to as S3, and the elastic force Fe of the fourth microshutter electrode 195-4 is referred to as S4, the elastic forces of the microshutter electrodes 195-1 to 195-4 may have the relationship as in Equation 5 below.

S1=S2=S3=S4 (Equation 5)

The overlapping areas, however, between the microshutter electrodes 195-1 to 195-4 and the small portions 191-1 to 191-4 of the pixel electrode 191 may be different from each other such that different static electricity forces Fs are formed and a larger static electricity force Fs is applied as the area increases even though the same voltage difference is provided. For example, when the static electricity force Fs of the first microshutter electrode 195-1 is referred to as F1, the static electricity force Fs of the second microshutter electrode 195-2 is referred to as F2, the static electricity force Fs of the third microshutter electrode 195-3 is referred to as F3, and the static electricity force Fs of the fourth microshutter electrode 195-4 is referred to as F4, the static electricity forces Fs applied to the microshutter electrodes 195-1 to 195-4 for the same voltage difference may have the relationship as in Equation 6 below.

F1>F2>F3>F4 (Equation 6)

Considering the elastic force Fe and the static electricity force Fs, the first microshutter electrode 195-1 where the static electricity force Fs largely acts is operated at a lower voltage. When the first threshold voltage of the first microshutter electrode 195-1 is referred to as Vth1, the second threshold voltage of the second microshutter electrode 195-2 is referred to as Vth2, the third threshold voltage of the third microshutter electrode 195-3 is referred to as Vth3, and the fourth threshold voltage of the fourth microshutter electrode 195-4 is referred to as Vth4, the threshold voltages Vth1 to Vth4 have the relationship as in Equation 7 below.

Vth1<Vth2<Vth3<Vth4 (Equation 7)

When considering the transmittance of the pixel according to the voltage applied to the microshutter electrodes 195-1 to 195-4 based on this equation, all microshutter electrodes 195-1 to 195-4 are opened below the first threshold voltage Vth1 such that the maximum transmittance is represented. Next, the first microshutter electrode 195-1 is closed at the first threshold voltage Vth1 such that the light transmitted through the first microshutter electrode 195-1 is blocked. In the present embodiment, the area of the first microshutter electrode 195-1 may be the largest, and the transmittance is decreased by the portion covered by the corresponding area. Next, the second microshutter electrode 195-2, the third microshutter electrode 195-3, and the fourth microshutter electrode 195-4 are respectively closed at the second threshold voltage Vth2, the third threshold voltage Vth3, and the fourth threshold voltage Vth4 such that the transmittance is decreased in proportion to the corresponding areas of the microshutter electrodes 195-2, 195-3, and 195-4 on the boundary of each threshold voltage, and the minimum transmittance is represented above the fourth threshold voltage Vth4.

In FIG. 7, the microshutter electrodes 195-1 to 195-4 and the small portions 191-1 to 191-4 of the pixel electrode 191 are arranged with an interval G between them. That is, the light may always be transmitted through the portion corresponding to the intervals G. Therefore, a light blocking member 220 such as a black matrix that additionally covers the portion corresponding to the intervals G for preventing light leakage may be formed. As described, the microshutter electrode is divided into four pieces; however, the microshutter electrode may be divided into a number more than or less than four according to an embodiment.

FIG. 8 is a view showing a pixel structure of a display device according to another embodiment of the present invention. In an embodiment according to FIG. 8, in contrast to an embodiment of FIG. 7, the widths W′ of the small portions of the pixel electrode 191 may be the same, and the widths W1′, W2′, W3′, and W4′ of the microshutter electrodes 195 may be different from each other. On the other hand, in the embodiment of FIG. 8, like the embodiment of FIG. 7, the microshutter electrodes 195 are formed with uniform interval G′, and the intervals G1, G2, and G3 between the small portions 191-1 to 191-4 of the pixel electrode 191 are different from each other. One end of each of the small portions 191-1 to 191-4 of the pixel electrode 191 and the microshutter electrodes 195-1 to 195-4 are respectively connected to each other, to which, thereby, the same voltages may be respectively applied.

As shown in FIG. 8, in the display device according to the current embodiment of the present invention, one pixel includes four microshutter electrodes 195-1 to 195-4 that are electrically connected to each other, to which, thereby, the same voltage is applied, and four small portions 191-1 to 191-4 of the pixel electrode 191 corresponding to the four microshutter electrodes 195-1 to 195-4. The microshutter electrodes 195-1 to 195-4 have the same length L2′; however, the widths W1′, W2′, W3′, and W4′ may be different, and the intervals G′ between the microshutter electrodes 195-1 to 195-4 may be uniform. One end of each of the microshutter electrodes 195-1 to 195-4 may be connected to each other, to which, thereby, the same voltage may be applied. In addition, four small portions 1914 to 191-4 of the pixel electrode that are insulated from the microshutter electrodes 195-1 to 1954 and respectively correspond to the microshutter electrodes 195-1 to 195-4 may be formed under the microshutter electrodes 195-1 to 195-4. The small portions 191-1 to 191-4 of each pixel electrode may have the same length L1′ and width W′. Also, the intervals G1′, G2′, and G3′ between the small portions 191-1 to 191-4 of each pixel electrode may be different. The small portions 191-1 to 191-4 of the pixel electrode may be disposed with reference to a central line in the length direction of the corresponding microshutter electrodes 195-1 to 195-4, and one end of each of the small portions 191-1 to 191-4 of each pixel electrode may be connected to each other, at which, thereby, the same voltage may be received.

The microshutter electrodes 195-1 to 195-4 may be made of the same material; however, the widths thereof may be different such that the microshutter electrodes 195-1 to 195-4 have different elastic forces Fe. For example, the microshutter electrode 195-1 having the narrower width may have the smaller elastic force Fe. When the elastic force Fe of the first microshutter electrode 195-1 is referred to as S1, the elastic force Fe of the second microshutter electrode 195-2 is referred to as S2, the elastic force Fe of the third microshutter electrode 195-3 is referred to as S3, and the elastic force Fe of the fourth microshutter electrode 195-4 is referred to as S4, the elastic forces of the microshutter electrodes 195-1 to 195-4 may have the relationship as in Equation 8 below.

S1<S2<S3<S4 (Equation 8)

The overlapping areas between the microshutter electrodes 195-1 to 195-4 and the small portions 191-1 to 191-4 of the pixel electrode may be the same such that the same static electricity forces Fs are generated. For example, when the static electricity force Fs of the first microshutter electrode 195-1 is referred to as F1, the static electricity force Fs of the second microshutter electrode 195-2 is referred to as F2, the static electricity force Fs of the third microshutter electrode 195-3 is referred to as F3, and the static electricity force Fs of the fourth microshutter electrode 195-4 is referred to as F4, the static electricity forces Fs applied to the microshutter electrodes 195-1 to 195-4 for the same voltage difference may have the relationship as in Equation 9 below.

F1=F2=F3=F4 (Equation 9)

Considering the elastic force Fe and the static electricity force Fs, the first microshutter electrode 195-1 at which the static electricity force Fs is small is operated at a lower voltage. When the first threshold voltage of the first microshutter electrode 195-1 is referred to as Vth1, the second threshold voltage of the second microshutter electrode 195-2 is referred to as Vth2, the third threshold voltage of the third microshutter electrode 195-3 is referred to as Vth3, and the fourth threshold voltage of the fourth microshutter electrode 195-4 is referred to as Vth4, the threshold voltages Vth1 to Vth4 may have the relationship as in Equation 10 below.

Vth1<Vth2<Vth3<Vth4 (Equation 10)

When considering the transmittance of the pixel according to the voltage applied to the microshutter electrodes 195-1 to 195-4 based on this equation, all microshutter electrodes 195-1 to 195-4 are opened below the first threshold voltage Vth1 such that the maximum transmittance is represented. Next, the first microshutter electrode 195-1 is closed at the first threshold voltage Vth1 such that the light transmitted through the first microshutter electrode 195-1 is blocked. In the present embodiment, the area of the first microshutter electrode 195-1 may be smallest, and the transmittance is decreased by the portion covered by the corresponding area. Next, the second microshutter electrode 195-2, the third microshutter electrode 195-3, and the fourth microshutter electrode 195-4 are respectively closed at the second threshold voltage Vth2, the third threshold voltage Vth3, and the fourth threshold voltage Vth4 such that the transmittance is decreased in proportion to the corresponding areas of the microshutter electrodes (195-2, 195-3, and 195-4 on the boundary of each threshold voltage, and the minimum transmittance is represented above the fourth threshold voltage Vth4.

In FIG. 8, the microshutter electrodes 195-1 to 195-4 and the small portions 191-1 to 191-4 of the pixel electrode are arranged with uniform intervals G′. For example, the light may always be transmitted through the portion corresponding to the intervals G′. Therefore, a light blocking member 220 such as a black matrix that additionally covers the portion corresponding to the intervals G′ for preventing light leakage may be formed. The light blocking member 220 may be formed under the pixel electrodes 191-1 to 191-4 or on the microshutter electrodes 195-1 to 195-4. As described, the microshutter electrode may be divided into four pieces; however, the microshutter electrode may be divided into a number more than or less than four according to an embodiment.

Additionally, FIG. 9 through FIG. 12 show other embodiments of the present invention for which the structure of the microshutter electrodes 195-1 to 195-4 may have uniform width such that there is little difference between the static electricity forces Fs generated, but different elastic forces Fe are applied. In FIG. 9 through FIG. 12, the microshutter electrodes 195-1 to 195-4 have the same widths and the same lengths, and the pixel electrode 191 is formed as one body on the total region including the microshutter electrodes 195-1 to 195-4, like the embodiments of FIG. 3 and FIG. 5. In FIG. 9 through FIG. 12, however, each of the microshutter electrodes 195-1 to 195-4 may have different elastic forces Fe, which will be described in detail.

In FIG. 9, the width of the portions (hereinafter, referred to as “high stress portions”, and indicated by “T” in the drawings) receiving the stress when the microshutter electrodes 195-1 to 195-4 are operated are different, thereby controlling the elastic force Fe. For example, it may be increasingly difficult to operate the microshutter electrodes 195-1 to 195-4 as the width of the high stress portion increases such that the elastic force Fe is increased. When the elastic force Fe of the first microshutter electrode 195-1 is referred to as S1, the elastic force Fe of the second microshutter electrode 195-2 is referred to as S2, the elastic force Fe of the third microshutter electrode 195-3 is referred to as S3, and the elastic force Fe of the fourth microshutter electrode 195-4 is referred to as S4, the elastic forces of the microshutter electrodes 195-1 to 195-4 may have the relationship as in Equation 11 below.

S1>S2>S3>S4 (Equation 11)

A larger static electricity force Fs may be required according to the increase of the elastic force Fe of the microshutter electrode such that the threshold voltage Vth to operate the microshutter electrode is increased. When the first threshold voltage of the first microshutter electrode 195-1 is referred to as Vth1, the second threshold voltage of the second microshutter electrode 195-2 is referred to as Vth2, the third threshold voltage of the third microshutter electrode 195-3 is referred to as Vth3, and the fourth threshold voltage of the fourth microshutter electrode 195-4 is referred to as Vth4, the threshold voltages Vth1 to Vth4 may have the relationship as in Equation 12 below.

Vth1>Vth2>Vth3>Vth4 (Equation 12)

Also, as in FIG. 10, additional films 196-1 to 196-3 may be formed on the portions (hereinafter, referred to as “a high stress portion(T)”), to which the stress is applied when the microshutter electrodes 195-1 to 195-4 are operated, to respectively control the elastic force Fe of the microshutter electrodes 195-1 to 195-4. For example, it may be more difficult for the microshutter electrodes 195-1 to 195-4 to be operated as the additional films 196-1 to 196-3 (and/or the thicknesses thereof) are increased on the high stress portion T such that the elastic force Fe is increased. When the elastic force Fe of the first microshutter electrode 195-1 is referred to as S1, the elastic force Fe of the second microshutter electrode 195-2 is referred to as S2, the elastic force Fe of the third microshutter electrode 195-3 is referred to as S3, and the elastic force Fe of the fourth microshutter electrode 195-4 is referred to as S4, the elastic forces of the microshutter electrodes 195-1 to 195-4 may have the relationship as in Equation 13 below.

S1>S2>S3>S4 (Equation 13)

A larger static electricity force Fs may be required according to the increase of the elastic force Fe of the microshutter electrode such that the threshold voltage Vth to operate the microshutter electrode is increased. When the first threshold voltage of the first microshutter electrode 195-1 is referred to as Vth1, the second threshold voltage of the second microshutter electrode 195-2 is referred to as Vth2, the third threshold voltage of the third microshutter electrode 195-3 is referred to as Vth3, and the fourth threshold voltage of the fourth microshutter electrode 195-4 is referred to as Vth4, the threshold voltages Vth1 to Vth4 may have the relationship as in Equation 14 below.

Vth1>Vth2>Vth3>Vth4 (Equation 14)

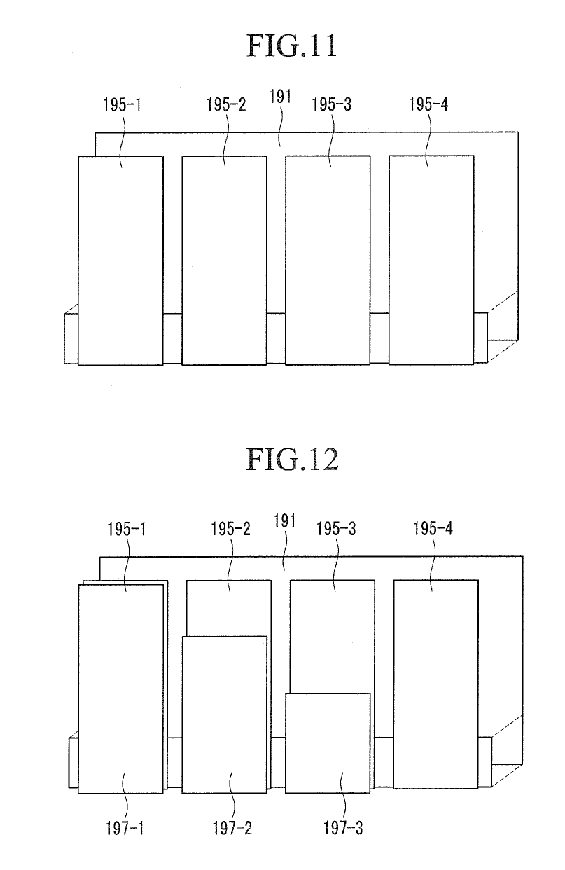

Also, in FIG. 11, the microshutter electrodes 195-1 to 195-4 may be made of different materials to control the elastic force Fe of the microshutter electrodes 195-1 to 195-4. For example, the elastic force of the material for the first microshutter electrode may be highest; the elastic force of the material may be decreased according to the sequence of the second microshutter electrode and the third microshutter electrode; and the fourth microshutter electrode may be formed of the material having the lowest elastic force. When the elastic force Fe of the first microshutter electrode 195-1 is referred to as S1, the elastic force Fe of the second microshutter electrode 195-2 is referred to as S2, the elastic force Fe of the third microshutter electrode 195-3 is referred to as S3, and the elastic force Fe of the fourth microshutter electrode 195-4 is referred to as S4, the elastic forces of the microshutter electrodes 195-1 to 195-4 may have the relationship as in Equation 15 below.

S1>S2>S3>S4 (Equation 15)

A larger static electricity force Fs may be required according to an increase of the elastic force Fe of the microshutter electrode such that the threshold voltage Vth to operate the microshutter electrode is increased. When the first threshold voltage of the first microshutter electrode 195-1 is referred to as Vth1, the second threshold voltage of the second microshutter electrode 195-2 is referred to as Vth2, the third threshold voltage of the third microshutter electrode 195-3 is referred to as Vth3, and the fourth threshold voltage of the fourth microshutter electrode 195-4 is referred to as Vth4, the threshold voltages Vth1 to Vth4 may have the relationship as in Equation 16 below.

Vth1>Vth2>Vth3>Vth4 (Equation 16)

Also, in FIG. 12, additional films 197-1 to 197-3 may be attached to the microshutter electrodes 195-1 to 195-4, and the lengths of the attached additional films 197-1 to 197-3 may be different from each other to control the elastic forces Fe of the microshutter electrodes 195-1 to 195-4. For example, the first additional film 197-1 may be formed on the whole surface on the first microshutter electrode, and the lengths of the additional films 197-2 and 197-3 may be decreased close to the second microshutter electrode 195-2 and the third microshutter electrode 195-3. Also, an additional film may not be formed on the fourth microshutter electrode 195-4. When the elastic force Fe of the first microshutter electrode 195-1 is referred to as S1, the elastic force Fe of the second microshutter electrode 195-2 is referred to as S2, the elastic force Fe of the third microshutter electrode 195-3 is referred to as S3, and the elastic force Fe of the fourth microshutter electrode 195-4 is referred to as S4, the elastic forces of the microshutter electrodes 195-1 to 195-4 may have the relationship as in Equation 17 below.

S1>S2>S3>S4 (Equation 17)

A larger static electricity force Fs may be required according to an increase of the elastic force Fe of the microshutter electrode such that the threshold voltage Vth to operate the microshutter electrode is increased. When the first threshold voltage of the first microshutter electrode 195-1 is referred to as Vth1, the second threshold voltage of the second microshutter electrode 195-2 is referred to as Vth2, the third threshold voltage of the third microshutter electrode 195-3 is referred to as Vth3, and the fourth threshold voltage of the fourth microshutter electrode 195-4 is referred to as Vth4, the threshold voltages Vth1 to Vth4 may have the relationship as in Equation 18 below.

Vth1>Vth2>Vth3>Vth4 (Equation 18)

As described, the elastic force Fe and the static electricity force Fs may be controlled through the various embodiments to control the different threshold voltages Vth, thereby representing the grays of the pixels.

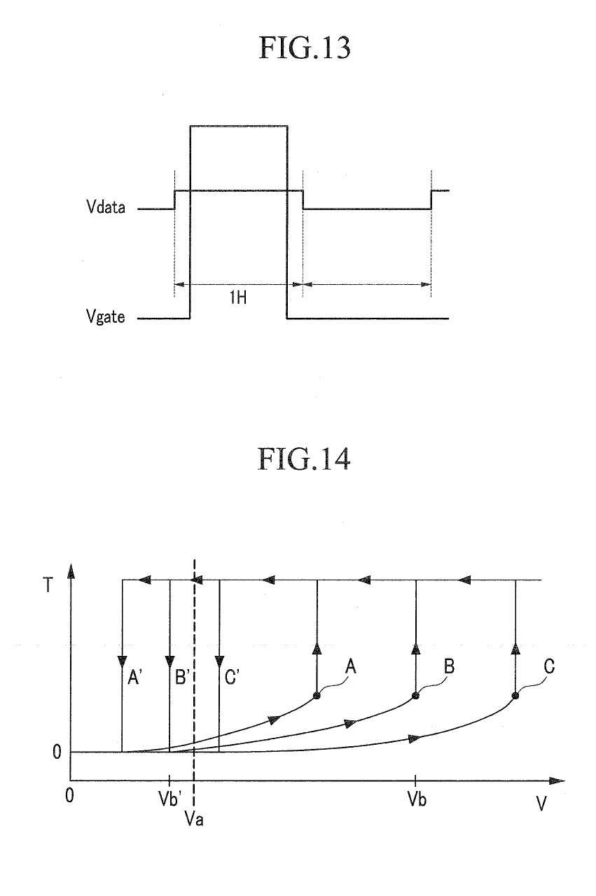

The thin film transistor (not shown) formed in these pixels may have a gate voltage Vgate and a data voltage Vdata applied as shown in FIG. 13. FIG. 13 is a waveform diagram of a gate voltage and a data voltage applied to a display device according to an embodiment of the present invention.

For example, if the gate voltage Vgate is applied, the thin film transistor connected thereto may be turned on, and the data voltage Vdata is applied to the microshutter electrode 195. By the applied voltage, a static electricity force may be generated between the pixel electrode 191 and the microshutter electrode 195, and if the static electricity force is larger than the elastic force Fe of the microshutter electrode 195, the microshutter electrode 195 may be closed. It is difficult, however, to drive the microshutter electrode 195 having a hysteresis of a voltage-transmittance (e.g., as shown in FIG. 14) through this driving method.

FIG. 14 is a graph showing hysteresis of a transmittance for a voltage of a display device according to an embodiment of the present invention. FIG. 14 shows the transmittance when increasing and again decreasing the voltage in a display device including three microshutter electrodes 195. Curved lines A, B, and C show the change of transmittance generated when the voltage is increased, thereby opening the microshutter electrodes 195, and curved lines A′, B′, and C′ show the change of transmittance generated when the voltage is decreased, thereby closing the microshutter electrodes 195. Also, the display device of FIG. 14 is an embodiment in which, if the voltage is increased, the microshutter electrode 195 is opened, and thereby the transmittance is improved, which is different from the embodiments of FIG. 1 to FIG. 12.

It will be described while focusing on the curved lines of B and B′, wherein if the voltage is gradually increased, the transmittance is maintained as the minimum transmittance until the microshutter electrode 195 is opened, and if the voltage increases over the threshold voltage Vb, the microshutter electrode 195 is suddenly opened such that the maximum transmittance is represented. Although the voltage is continuously increased, the maximum transmittance is maintained. Next, when the voltage is gradually decreased, the microshutter electrode 195 is not closed near the threshold voltage Vb such that the transmittance is maintained as the maximum transmittance, and when the voltage decreases to the Vb′ voltage (referred to as a threshold voltage where the microshutter electrode 195 is closed), the microshutter electrode 195 is closed such that the transmittance is returned to the minimum transmittance. Accordingly, the threshold voltage Vb upon opening and the threshold voltage Vb′ upon closing are different from each other such that the hysteresis characteristics as in FIG. 14 appear. On the other hand, in FIG. 14, if the voltage is increased, the transmittance is increased; this is the reason that the leakage light is generated while the microshutter electrode 195 is moved by the static electricity force Fs.

In FIG. 14, the microshutter electrode indicated by A and A′ (hereinafter referred to as the “A microshutter electrode”) has a lower threshold voltage than that of the microshutter electrode (hereinafter referred to as the “B microshutter electrode”) indicated by B and B′, and the microshutter electrode (hereinafter referred to as the “C microshutter electrode”) indicated by C and C′ has a larger threshold voltage than that of the B microshutter electrode.

When the A, B, and C microshutter electrodes are formed in one pixel and closing only the B microshutter electrode in the state in which the A and B microshutter electrodes are opened, the B microshutter electrode is not closed although a lower voltage than the threshold voltage Vb is applied. For example, although the voltage is reduced below the Va voltage of FIG. 14, the voltage is higher than the threshold voltage Vb′ to close the B microshutter electrode such that it is maintained that the B microshutter electrode is opened. Thus, when the display device has hysteresis characteristics, the threshold voltage upon closing may be separately stored such that the voltage of less than the threshold voltage upon closing may be applied to close the microshutter electrode. However, when a plurality of microshutter electrodes are formed in one pixel, the threshold voltage upon closing is formed as a plurality thereof in a narrow voltage range such that there are problems that it may be difficult to control the threshold voltage, and the fact that the microshutter electrode is opened must be determined whenever closing the microshutter electrode.

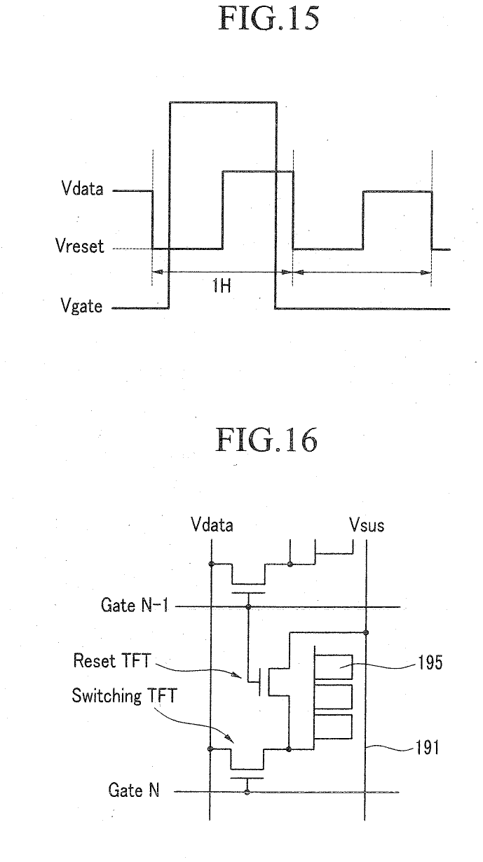

To solve these problems, in accordance with one or more embodiments of the present invention, a display device may be driven by a method of FIG. 15, and a display device including a structure shown in FIG. 16 may be used. The driving method of FIG. 15 will first be described. FIG. 15 is a waveform diagram of a gate voltage and a data voltage applied to a display device according to another embodiment of the present invention.

If the gate-on voltage is applied, the thin film transistor connected thereto is turned on such that voltage applied to the data line is applied to the microshutter electrode 195. The voltage applied to the microshutter electrode 195 has two levels during the period 1H in which the gate-on voltage is applied. For example, a voltage of a Vreset level and a data voltage Vdata that will be applied to the microshutter electrode may be applied. The Vreset voltage may be the low voltage to return all microshutter electrodes to the original state (the closed state in FIG. 14, and the opened state in FIG. 1 to FIG. 12) under the hysteresis of FIG. 14.

In this way, if the voltage is applied, although the microshutter electrode is moved (the opened state in FIG. 14, and the closed state in FIG. 1 to FIG. 12) due to the data voltage Vdata before one frame, the microshutter electrode is returned to the original state by the Vreset voltage, and the voltage is again applied such that the microshutter electrode is operated into the desired state. As a result, the problems generated by the hysteresis of FIG. 14 are removed.

FIG. 16 shows an embodiment changing the pixel structure of the pixel to remove the problems due to hysteresis. As shown in FIG. 16, one pixel according to an embodiment of the present invention includes a switching TFT connected to an N-th gate line and a data line, a reset TFT connected to an (N−1)-th gate line and the data line, at least two microshutter electrodes 195, and a pixel electrode 191.

The switching TFT and the reset TFT respectively include a gate electrode, a source electrode, and a drain electrode; the gate electrode of the switching TFT is connected to the corresponding (e.g., N-th) gate line; the source electrode of the switching TFT is connected to the data line; and the drain electrode of the switching TFT is connected to the microshutter electrode 195. On the other hand, the gate electrode of the reset TFT is connected to the previous (e.g., (N−1)-th) gate line, the source electrode of the reset TFT is connected to the pixel electrode 191, and the drain electrode of the reset TFT is connected to the microshutter electrode 195 and the drain electrode of the switching TFT. Here, the pixel electrode 191 is connected to the ground voltage Vsus, and although indicated as a simple line in FIG. 16, at least a portion thereof actually overlaps the microshutter electrode 195.

The display device including the pixel with the above-described structure may be driven with the method of FIG. 15. The operation of the pixel is described as follows.

The gate-on voltage is applied to the previous, (N−1)-th, gate line. Thus, the switching TFT of the previous pixel is turned on, and the reset TFT of the corresponding, N-th, pixel is turned on. If the reset TFT is turned on, the ground voltage Vsus is applied to the microshutter electrode 195. The ground voltage Vsus is the same as the voltage applied to the pixel electrode 191 such that the static electricity force is not generated between the pixel electrode 191 and the microshutter electrode 195, and thereby the microshutter electrode 195 acquires the original state.

Next, if the gate-on voltage is applied to the corresponding, N-th, gate line, the switching TFT of the corresponding, N-th, pixel is turned on, and as a result the data voltage applied from the data line is applied to the microshutter electrode 195. Accordingly, the static electricity force is generated between the pixel electrode 191 and the microshutter electrode 195 such that the microshutter electrode 195 may be operated, or not, according to the elastic force Fe and the static electricity force Fs thereof.

The embodiment of FIG. 16 is the structure in which the reset TFT is added to the general pixel, and the voltage of the microshutter electrode 195 is initialized when the gate-on voltage is applied to the previous gate line. This concept may be similar to additionally applying the Vreset voltage to the driving method of FIG. 13.

In the above description, the display device having a structure in which the voltage is applied to close the microshutter electrode under the state in which the microshutter electrode is opened is explained. However, a structure in which the voltage is applied to open the microshutter electrode under the state in which the microshutter electrode is closed may be formed. Also, in the above description, the embodiment in which the microshutter electrode and the pixel electrode have different polarities such that the attraction force is enhanced according to the application of the voltage is described. However, in another embodiment, two electrodes may have the same polarity such that the repulsive force may be enhanced according to the application of the voltage. In the above-described embodiment, if the microshutter electrodes having different elastic forces are electrically connected to each other to apply the same voltage, and the microshutter electrodes are operated through the different voltages, concepts of embodiments of the present invention are included.

While embodiments of this invention have been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
an insulation substrate;
a pixel electrode formed on the insulation substrate, and made of a transparent conductive material;
an insulating layer disposed on the pixel electrode; and
at least two microshutter electrodes, wherein the microshutter electrodes are:
disposed on the insulating layer,
made of a non-transparent conductive material for blocking light,
electrically connected to each other so that a same voltage is applied to both, and
opened and closed by applying different voltages.

2. The display device of claim 1, wherein the microshutter electrodes are opened and closed through a static electricity force between the microshutter electrodes and the pixel electrode, and an elastic force of the microshutter electrodes.

3. The display device of claim 2, wherein the microshutter electrodes have different elastic forces.

4. The display device of claim 3, wherein the microshutter electrodes have uniform widths.

5. The display device of claim 3, wherein the microshutter electrodes have different widths.

6. The display device of claim 3, wherein:
the microshutter electrodes have a high stress portion meeting a portion where they are moved, and a fixed portion where they are fixed to each other, and
the widths of the high stress portions of the microshutter electrodes are different.

7. The display device of claim 3, further comprising an additional film covering the high stress portion, wherein:
the microshutter electrodes have a high stress portion meeting a portion where they are moved and a fixed portion where they are fixed to each other, and
the additional film has different lengths or is included at a different number per microshutter electrode.

8. The display device of claim 3, wherein the microshutter electrodes are made of different materials.

9. The display device of claim 3, further comprising an additional film covering the microshutter electrodes, wherein the additional film has different lengths per microshutter electrode.

10. The display device of claim 2, wherein the static electricity forces between the pixel electrode and the microshutter electrodes are different from each other.

11. The display device of claim 10, wherein the pixel electrode includes at least two small portions corresponding to the microshutter electrodes and separated from each other by a predetermined interval.

12. The display device of claim 11, wherein a central line of the small portions accord with a central line of the microshutter electrodes.

13. The display device of claim 11, wherein overlapping widths between the small portions and the microshutter electrodes are the same.

14. The display device of claim 11, wherein overlapping widths between the small portions and the microshutter electrodes are different from each other.

15. The display device of claim 11, wherein one end of each of the small portions are connected to each other.

16. The display device of claim 1, further comprising a light blocking member blocking light transmitted between the microshutter electrodes.

17. The display device of claim 1, further comprising a thin film transistor electrically connected to the pixel electrode or the microshutter electrodes.

18. The display device of claim 1, further comprising:
a gate line;
a data line; and
a switching transistor and a reset transistor each including, respectively, a gate electrode, a source electrode, and a drain electrode,
wherein the gate electrode of the switching transistor is connected to a corresponding gate line, the source electrode of the switching transistor is connected to a data line, and the drain electrode of the switching transistor is connected to the microshutter electrodes, and
the gate electrode of the reset transistor is connected to a previous gate line, the source electrode of the reset transistor is connected to the pixel electrode, and the drain electrode of the reset transistor is connected to the microshutter electrodes.

19. A method for driving a display device that includes a pixel electrode made of a transparent conductive material; at least two microshutter electrodes made of a non-transparent conductive material for blocking light, electrically connected to each other so that the same voltage is applied to each, and opened and closed through different voltages; a gate line; a data line; and a thin film transistor connected to the gate line, the data line, and the pixel electrode or the microshutter electrodes; the method comprising:
applying a gate-on voltage to the gate line; and
alternately applying a reset voltage and a data voltage to the data line, wherein:
the reset voltage and the data voltage are applied for at least respective portions of a time during which the gate-on voltage is applied, and
the reset voltage is applied before the data voltage.

20. The method of claim 19, wherein the reset voltage is a voltage to initialize all of the microshutter electrodes.
